(19) United States
(12) Patent Application Publication
(10) Pub. No.: US 2007/0267525 A1
(43) Pub. Date: Nov. 22, 2007

(54) Shredder having an illuminating module

(75) Inventor: Tie Chun Wang, SanChung City (TW)

Correspondence Address: BACON & THOMAS, PLLC, 625 SLATERS LANE, FOURTH FLOOR, ALEXANDRIA, VA, 22314, US

(73) Assignee: Michilin Prosperity Co., Ltd., SanChung City (TW)

(21) Appl. No.: 11/797,673

(22) Filed: May 7, 2007

(30) Foreign Application Priority Data
May 19, 2006 (TW) 095208581

(51) Int. Cl. B02B 5/00

(52) U.S. Cl. 241/7

(57) ABSTRACT

Disclosed is a shredder, where the shredder is provided with an illuminating module neighboring a control panel or paper inlet thereof. The illuminating module is electrically connected to an activating circuit of the shredder motor, such that illuminators of the illuminating module are illuminated at the same time of activating a motor for driving the paper shredding cutter, and turned off at the same of deactivating the motor after completing the shredding, so as to feature the shredding operation with playful interest.

### CROSS-REFERENCES TO RELATED APPLICATIONS

Not Applicable

### STATEMENT REGARDING FEDERALLY SPONSORED RESEARCH OR DEVELOPMENT

Not Applicable

### DESCRIPTION

1. Field of Invention

This invention relates to a shredder, particular to one having an illuminating module so as to feature the shredding operation with playful interest.

2. Background

The conventional shredders for cutting paper use a plurality of cutting blades and spacers engaging over a rotary shaft, and the shearing force that two parallel and opposite rotary shafts produce by a motor and a gear box for transferring and cutting the paper-to-be-cut along a longitudinal direction into strips. Shredders can be classed into two types, the stripe-cut shredders and crosscut shredders, according to the machine cutting style. The former shredders arrange cutting blades to the rotating shafts in a manner to cutting the paper in a longitudinal direction to form strips. The later shredders include blades that include more than one cutting edge part, and each cutter is disposed helically along the rotary shaft for first cutting paper along a horizontal direction into strips and then cutting paper along a longitudinal direction into approximate 4 mm×40 mm paper chips. Regardless of being stripe-cut shredders and crosscut shredders, a basket or bin for containing paper chips usually accompanies the shredder at sales.

The maximum sheet capacity of the conventional paper shredders is dependent on the motor load and the limitations of the cutting blades and rotary shafts. Thus, when a large amount of paper is to be destroyed, the user must continuously feed the paper that is within the maximum sheet capacity of the paper shredded into the paper shredder manually in order to destroy the entire batch of documents. Experiences show that, continuous and repetitive shredding operations are simple and dull. Therefore, the industry has attempted to feature the shredding operation with playful interest so as to win consumers' favors.

### SUMMARY OF INVENTION

It is a primary object of this invention to provide a shredder having an illuminating module, where illuminators of the illuminating module are illuminated at the same time of activating a motor for driving the paper shredding cutter, and turned off at the same of deactivating the motor after completing the shredding, so as to feature the shredding operation with playful interest.

To achieve the above object, this invention provides a shredder, where the shredder is provided with an illuminating module neighboring a control panel or paper inlet thereof. The illuminating module is electrically connected to an activating circuit of the shredder motor, such that illuminators of the illuminating module are illuminated at the same time of activating a motor for driving the paper shredding cutter, and turned off at the same of deactivating the motor after completing the shredding, so as to feature the shredding operation with playful interest.

### BRIEF DESCRIPTION OF THE DRAWINGS

These and other modifications and advantages will become even more apparent from the following detailed description of a preferred embodiment of the invention and from the drawings in which:

FIG. 1 is a schematic drawing illustrating an illuminating module neighboring a control panel of a shredder according to this invention; and

FIG. 2 is a schematic drawing illustrating an illuminating module neighboring a paper inlet of a shredder according to this invention.

### DETAILED DESCRIPTION OF THE INVENTION (PREFERRED EMBODIMENTS)

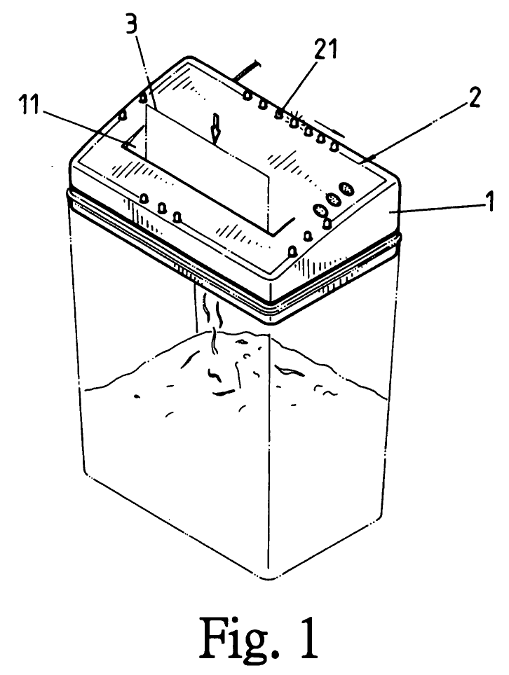

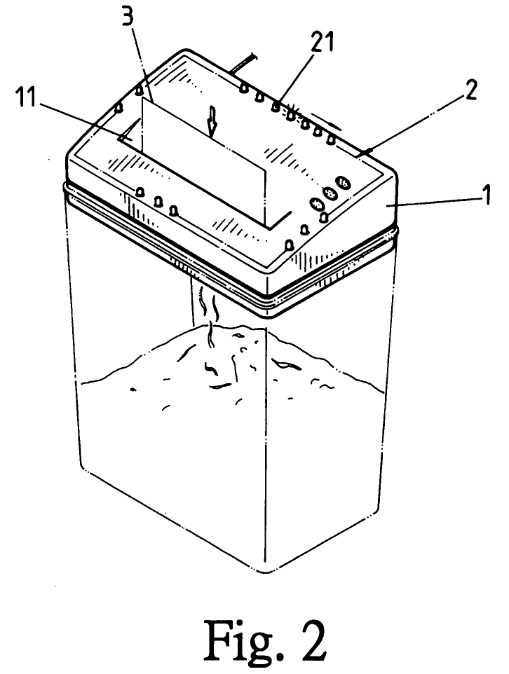

With reference t the drawings, FIGS. 1 and 2 illustrate an illuminating module neighboring a control panel and a paper inlet of a shredder, respectively.

As shown, the shredder 1 is provided with at least one illuminating module 2 neighboring a control panel or paper inlet 11 thereof. The illuminating module 2 may include illuminators 21 such as plural light emitting diodes (LED) or any other kind of lighting source, and the illuminating module 2 is electrically connected to a motor activating circuit (not shown) of the shredder 1, such that illuminators 21 of the illuminating module 2 are illuminated at the same time of activating a motor for driving the paper shredding cutter 12, and turned off at the same of deactivating the motor after completing the shredding. Thus, during shredding operation, non-precedent visual effects can thus been rendered by the illumination of the illuminating module so as to enhance playful interest provided by the shredding operation.

Furthermore, the plural LED illuminators 21 may be of a colorful RGB module (RGB) or a running information LED display mode may be adopted to enhance lighting variations, so as to stimulate visual sense and to enhance playful interest provided by the shredding operation.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A shredder having an illuminating module, including: at least one illuminating module having plural illuminators, the illuminating module being electrically connected to a motor activating circuit of the shredder, such that the illuminators of the illuminating module are illuminated at the same time of activating a motor for driving the paper shredding cutter, and turned off at the same of deactivating the motor after completing the shredding.

2. The shredder having an illuminating module according to claim 1, wherein the illuminating module neighbors a control panel of the shredder.

3. The shredder having an illuminating module according to claim 1, wherein the illuminating module neighbors a paper inlet of the shredder

4. The shredder having an illuminating module according to claim 1, wherein the illuminators are each a light emitting diode (LED).

5. The shredder having an illuminating module according to claim 4, wherein the plural LED illuminators are of a colorful RGB module or running information LED display to enhance lighting variations.

6. The shredder having an illuminating module according to claim 4, wherein the illuminators are any other type of lighting source.
